(19) United States
(12) Patent Application Publication
(10) Pub. No.: US 2025/0262954 A1
(43) Pub. Date: Aug. 21, 2025

(54) ELECTRIC VEHICLE PROPULSION SYSTEM

(71) Applicant: GM GLOBAL TECHNOLOGY OPERATIONS LLC, Detroit, MI (US)

(72) Inventors: John C. Lyons, Canton, MI (US); Shuonan Xu, Troy, MI (US)

(73) Assignee: GM GLOBAL TECHNOLOGY OPERATIONS LLC, Detroit, MI (US)

(21) Appl. No.: 18/443,377

(22) Filed: Feb. 16, 2024

(51) Int. Cl. B60L 50/60; B60K 1/02; B60K 7/00; H01M 50/204; H01M 50/249

(52) U.S. Cl. CPC B60L 50/60; B60K 1/02; B60K 7/0007; H01M 50/204; H01M 50/249; H01M 2220/20

(57) ABSTRACT

A powertrain system includes a first traction battery pack and a first drive unit in electrical communication with the first traction battery pack for driving at least one first wheel. A first charge receptacle is in electrical communication with the first traction battery pack and a second traction battery pack is configured to drive at least one wheel and is electrically isolated from the first traction battery pack.

### INTRODUCTION

Electrified powertrain systems of motor vehicles and other mobile electrical systems include an electrical system configured to energize one or more electric motors to generate motive torque. For example, an electric traction motor may be connected to road wheels of an electric vehicle, with generated output torque being directed to the road wheels to propel the electric vehicle on a road surface. To this end, a high-voltage bus of the electric vehicle is connected to a rechargeable energy storage system (“RESS”), a principal component of which is a propulsion battery pack having an application-suitable number and configuration of electrochemical battery cells. The battery pack-to-motor connection is made through an intervening power inverter module when the electric traction motor is configured as polyphase/alternating current (“AC”) machine.

### SUMMARY

Disclosed herein is a powertrain system. The system includes a first traction battery pack and a first drive unit in electrical communication with the first traction battery pack for driving at least one first wheel. A first charge receptacle is in electrical communication with the first traction battery pack and a second traction battery pack is configured to drive at least one wheel and is electrically isolated from the first traction battery pack.

Another aspect of the disclosure may be where the second traction battery pack is in electrical communication with a second drive unit that is configured to drive at least one second wheel and the second traction battery pack is electrically isolated from the first charge receptacle.

Another aspect of the disclosure may be where the first traction battery pack includes a first battery chemistry and the second traction battery pack includes a second battery chemistry different from the first battery chemistry.

Another aspect of the disclosure may be where the at least one first wheel includes a pair of first wheels and the first drive unit includes a hub motor associated with each of the pair of first wheels.

Another aspect of the disclosure may be where the first traction battery pack includes a first plurality of battery modules located in a first battery housing and a second plurality of battery modules located in a second battery housing.

Another aspect of the disclosure may be where the first traction battery pack includes a switch for selectively forming an electrical connection with the first plurality of battery modules or the second plurality of battery modules.

Another aspect of the disclosure may be where in the first traction battery pack includes an output switch for selectively forming an electrical connection between the first drive unit and one of the first plurality of battery modules or the second plurality of battery modules.

Another aspect of the disclosure may be where the first drive unit is in electrical communication with the first traction battery pack through a first inverter and the second drive unit is in electrical communication with the second traction battery pack through a second inverter.

Disclosed herein is a vehicle system. The system includes a vehicle body supported by a first pair of wheels and a second pair of wheels. A first traction battery pack and a first drive unit in electrical communication with the first traction battery pack and in driving engagement with at least one of the first pair of wheels. A first charge receptacle in electrical communication with the first traction battery pack and a second traction battery pack electrically isolated from the first traction battery pack.

Another aspect of the disclosure may be where the second traction battery pack is in electrical communication with a second drive unit that is configured to drive at least one second wheel and the second traction battery pack is electrically isolated from the first charge receptacle.

Another aspect of the disclosure may be where the first traction battery pack includes a first battery chemistry and the second traction battery pack includes a second battery chemistry different from the first battery chemistry.

Another aspect of the disclosure may be where the first traction battery pack includes a first plurality of battery modules and a second plurality of battery modules with one of the first plurality of battery modules or the second plurality of battery modules being fixedly attached to the vehicle body and the other of the first plurality of battery modules or the second plurality of battery modules being removably attached to the vehicle body.

Another aspect of the disclosure may be where the first traction battery pack includes a switch for selectively forming an electrical connection with the first plurality of battery modules or the second plurality of battery modules. Another aspect of the disclosure may be where in the first traction battery pack includes an output switch for selectively forming an electrical connection between the first drive unit and one of the first plurality of battery modules or the second plurality of battery modules.

Another aspect of the disclosure may be where the first plurality of battery modules are located in a first battery housing and the second plurality of battery modules are located in a second battery housing separate from the first battery housing.

Disclosed herein is a method of operating a vehicle. The method includes receiving a desired operating request for the vehicle and analyzing current operating conditions of the vehicle. In one example, the desired operating request can include a requested velocity for the vehicle. A mode of operation for the vehicle is selected based on analyzing the current operating conditions and the desired operating request. Selecting the mode of operating includes operating a first drive unit in connection with a first traction battery pack to drive at least one first wheel on the vehicle and operating a second drive unit in connection with a second traction battery pack to drive at least one second wheel on the vehicle with the second traction battery pack being electrically isolated from the first traction battery pack.

Another aspect of the disclosure may be where operating the second drive unit includes operating the second drive unit as a motor to output a rotational force.

Another aspect of the disclosure may be where operating the second drive unit includes operating the second drive unit as a generator to charge the second traction battery pack.

Another aspect of the disclosure may be where the first drive unit is operated at a first voltage level, the second drive unit is operated at a second voltage level different from the first voltage level, and the current operating conditions of the vehicle include at least one of ambient temperature, a state of charge of the first traction battery pack or the second traction battery pack, or an operating temperature of the first traction battery pack or the second traction battery pack.

Another aspect of the disclosure may include charging the first traction battery pack through a first charge receptacle on the vehicle, wherein the first charge receptacle is isolated from the second traction battery pack.

### BRIEF DESCRIPTION OF THE DRAWINGS

FIG. 1 schematically illustrates an example electrified powertrain system for a vehicle.

FIG. 2 schematically illustrates the electrified powertrain system of FIG. 1 incorporated into a vehicle.

FIG. 3 schematically illustrates another example electrified powertrain system for a vehicle.

FIG. 4 schematically illustrates the electrified powertrain system of FIG. 3 in a first example configuration.

FIG. 5 schematically illustrates the electrified powertrain system of FIG. 3 in a second example configuration.

FIG. 6 schematically illustrates yet another example electrified powertrain system for a vehicle with the electrified powertrain system in a first example configuration.

FIG. 7 schematically illustrates the electrified powertrain system of FIG. 6 in a second example configuration.

FIG. 8 is a flowchart for a method of operating an electrified vehicle having multiple traction batteries.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

The present disclosure is susceptible to embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly outlined in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive. The words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function can perform the specified function without alteration, rather than merely having the potential to perform the specified function after further modification. In other words, the described hardware, when expressly configured to perform the specified function, is specifically selected, created, implemented, utilized, programmed, and/or designed to perform the specified function.

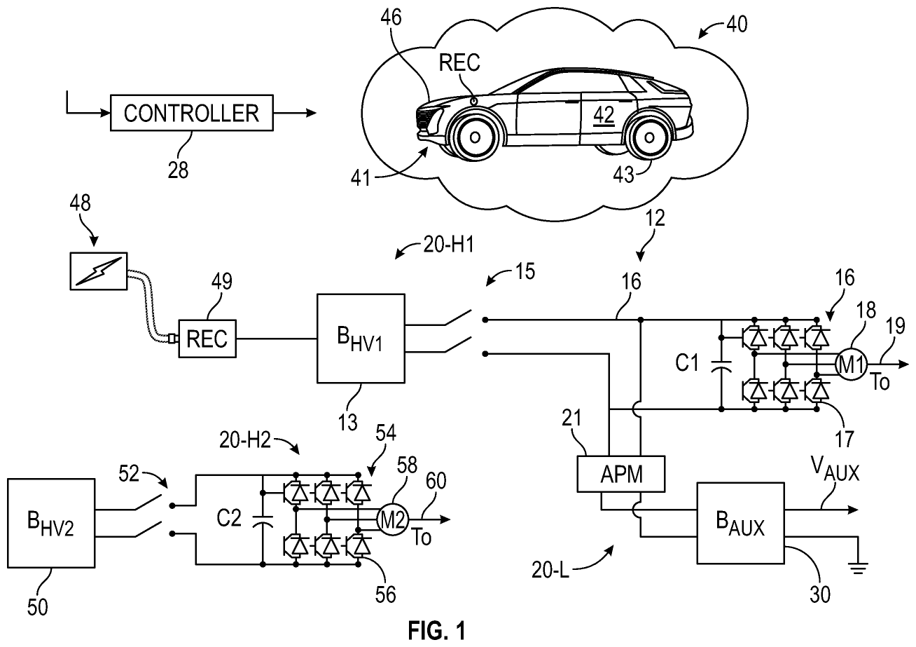

Referring to the drawings, like reference numerals correspond to like or similar components throughout the several Figures. FIG. 1 illustrates an electrical system 12, e.g., an electrified powertrain system of a motor vehicle 40 having a vehicle body 41 defining a vehicle interior 42. The motor vehicle 40 of FIG. 1 may also include a front trunk (“frunk”) 46 or another compartment providing user access to a charging receptacle REC. The motor vehicle 40 also includes road wheels 43 for traveling along roadways. The wheels 43 may be driven/powered through the electrical system 12 or undriven/freewheeling, as described in greater detail below.

The electrical system 12 includes separate high-voltage and low-voltage buses. A first high-voltage bus 20-H1 is in electrical communication with a first high-voltage battery pack assembly 13, such as a first traction battery, a second high-voltage bus 20-H2 is in electrical communication with a second high-voltage battery pack 50, such as a second traction battery pack, and the low-voltage bus 20-L is in electrical communication with an auxiliary battery (“B_{AUX}”) 30.

At least one auxiliary power module (“APM”) 21 isolates the high-voltage buses 20-H1 and 20-H2 from the low-voltage bus 20-L with input in communication with the high-voltage bus 20-H1 and outputs in communication with the low-voltage bus 20-L to charge the auxiliary battery 30 and power vehicle accessories, such as heated seats, power windows, or navigation systems.

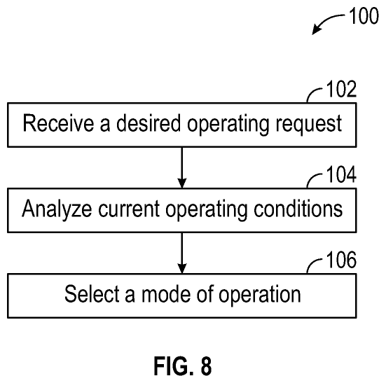

The electronic controller 28 may include a computer and/or processor, and include software, hardware, memory, algorithms, connections, etc., for managing and controlling the operation of the motor vehicle 40. As such, a method, described below and generally represented in FIG. 8, may be embodied as a program or algorithm partially operable on the controller 28. It should be appreciated that the controller 28 may include a device capable of analyzing data from the sensors, comparing data, making the decisions required to control the operation of the motor vehicle 40, and executing the required tasks to control the operation of the motor vehicle 40.

The controller 28 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

The controller 28 includes a tangible, non-transitory memory on which computer-executable instructions, including one or more algorithms, are recorded for regulating operation of the motor vehicle 40. The subject algorithm(s) may specifically include an algorithm configured to operate the motor vehicle 40.

Further, concerning the representative electrical system 12 of FIG. 1, the electrical system 12 is characterized by a separate first high-voltage 20-H1, a second high-voltage bus 20-H2, and low-voltage buses 20-L. For embodiments in which the electrical system 12 is part of the motor vehicle 40, e.g., an electric vehicle constructed as a battery electric vehicle, a hybrid electric vehicle, or an extended-range electric vehicle, the term “high-voltage” may encompass battery voltage capabilities of about 300 volts (V) or more. Such voltage levels are suitable for generating motive torque for vehicular propulsion functions and for powering various high-voltage accessories aboard the motor vehicle 40. The term “low-voltage” for its part refers to auxiliary voltage levels, typically 12-50V. Low-voltage conductors (not shown) thus connect the low-voltage bus 20-L to one or more low-voltage accessories located aboard the motor vehicle 40, including but not limited to lights, radios, infotainment screens, sensors, etc.

In the exemplary embodiment of FIG. 1, the first battery pack assembly 13 is selectively connected to and disconnected from a load by a set of high-voltage contactors 15. The applied load in the illustrated configuration includes a DC link capacitor (C1), a power inverter module (“inverter”) 16 having a plurality of semiconductor switches 17 connected to a drive unit, such as an electric traction motor (“M”) 18. As appreciated in the art, inverters such as the inverter 16 shown in FIG. 1 utilize multiple dies of the semiconductor switches 17 as fast-responding ON/OFF switching devices, e.g., insulated gate bipolar transistors (“IGBTs”), metal oxide semiconductor field-effect transistors (“MOSFETs”), thyristors, etc. In a typical three-phase configuration of the electric traction motor 18, the semiconductor switches 17 are turned ON or OFF at predetermined switching intervals to output an alternating current (“AC”) waveform to the electric traction motor 18.

The electric traction motor 18 shown in FIG. 1 is connected to a rotatable output member 19, such as a motor shaft and connected gears (not shown). During drive modes, the inverter 16 is controlled with pulse width modulation (“PWM”) or another application-suitable switching control technique to energize phase windings of the electric traction motor 18. As depicted, the electric traction motor 18 is a polyphase AC motor, in this instance exemplified as a three-phase machine. Rotation of the output member 19 ultimately transfers torque (To) to a coupled load, including one or more road wheels 43 of the motor vehicle 40. During discharge/propulsion modes, electrical energy stored in constituent electrochemical battery cells (not shown) of the high-voltage battery pack assembly 13 is used to power rotation of one or more of the road wheels 43. Other embodiments of the motor vehicle 40 may use more or fewer road wheels 43. Additionally, some of the road wheels 43 could be undriven/freewheeling, e.g., in rear-wheel drive or front-wheel drive configurations, or the road wheels 43 may be driven/powered, e.g., in an all-wheel drive or four-wheel drive configuration, without limitation.

The second traction battery pack 50 is selectively connected to and disconnected from a load by a set of high-voltage contactors 52. The applied load in the illustrated configuration includes a DC link capacitor (C2), a power inverter module (“inverter”) 54 having a plurality of semiconductor switches 56 connected to a drive unit, such as an electric traction motor (“M2”) 58, as described above with respect to the inverter 16.

The electric traction motor 58 shown in FIG. 1 is connected to a rotatable output member 60, such as a motor shaft and connected gears (not shown). During drive modes, the inverter 54 is controlled with pulse width modulation (“PWM”) or another application-suitable switching control technique to energize phase windings of the electric traction motor 58. As depicted, the electric traction motor 58 is a polyphase AC motor, in this instance exemplified as a three-phase machine. Rotation of the output member 60 ultimately transfers torque (To) to a coupled load, including one or more road wheels 43 of the motor vehicle 40. During discharge/propulsion modes, electrical energy stored in constituent electrochemical battery cells (not shown) of the second traction battery pack 50 is used to power rotation of one or more of the road wheels 43.

One feature of having the first traction battery pack 13 separate from the second traction battery pack 50 is the ability to use different methods of managing temperature within the packs. For example, the first traction battery pack may have a cell face cooling assembly while the second traction battery pack 50 could utilize an edge cooling assembly.

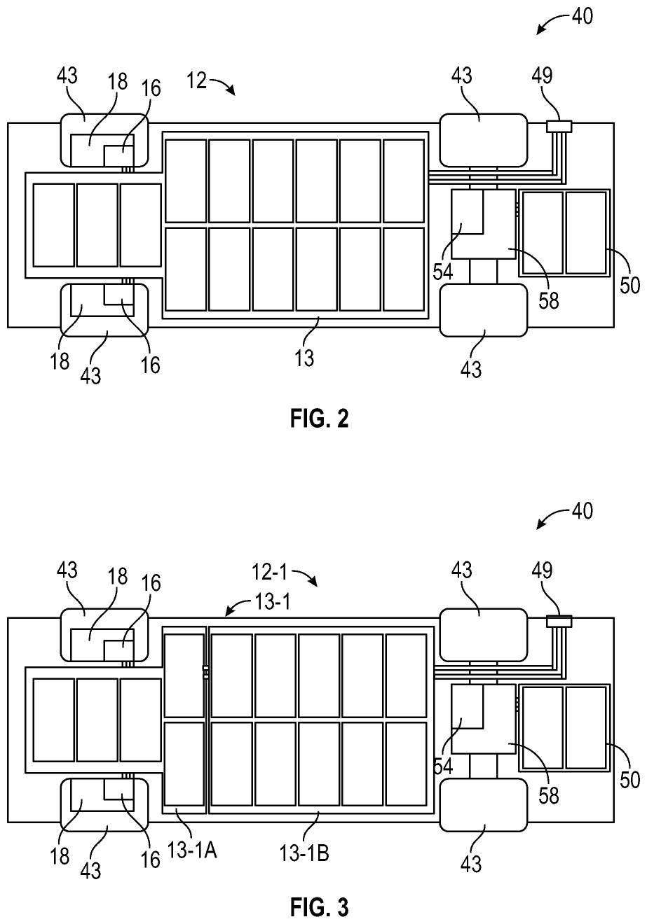

FIG. 2 schematically illustrates the electrical system 12 of FIG. 1 incorporated into the vehicle 40. In the illustrated example, a first pair of wheels 43 on the vehicle 40 are driven by hub mounted motors 18. The motor(s) 18 are in electrical communication with the first traction battery pack 13 through at least one corresponding inverter 16. However, the first pair of wheels 43 could be driven by a single motor 18 that proves rotational force through individual axles to the wheels 43. The first traction battery pack 13 is in electrical communication with the charge receptacle 49 to charge the first traction battery pack 13. The motor(s) 18 can also operate with a regenerative function to generate power to charge the first traction battery pack 13 during operation of the vehicle 40.

A second pair of the wheels 43 opposite the first pair of wheels 43 are driven by the motor 58. The motor 58 is in electrical communication with the second traction battery pack 50 through the inverter 54. In the illustrated example, the second traction battery pack 50 is electrically isolated from the first traction battery pack 13 such that the first high-voltage bus 20-H1 can operate at a different voltage from the second high-voltage bus 20-H2. In one example, the first high-voltage bus 20-H1 can operate at 800V and the second high-voltage bus 20-H2 can operate at 400V. This allows for different sizing of components, such as bus bars, between the first and second high-voltage buses 20-H1 and 20-H2.

The second high-voltage bus 20-H2 and the second traction battery pack 50 are also electrically isolated from charge receptacle 49 such that the second traction battery pack 50 cannot be charged by a power source external to the vehicle 40. The second traction battery pack 50 can be charged through regenerative operations by the motor 58. Therefore, while the motor(s) 18 are driving the vehicle 40, the motor 58 can operate as a generator to charge the second traction battery pack 50 until a charge level in the second traction battery pack 50 has reached a predetermined level of charge or is within a predetermined charge range.

One feature of having the first and second high-voltage buses 20-H1 and 20-H2 being electrically isolated from each other is the elimination of utilizing a DC-DC converter to match the output voltages between the first traction battery pack 13 and the second traction battery pack 50. The elimination of the DC-DC converter reduces the complexity and number of components in the electrical system 12.

Furthermore, the first traction battery 13 includes a plurality of battery modules having battery cells with a first battery chemistry and the second traction battery pack 50 includes a second plurality of battery modules having battery cells with a second battery chemistry that is different from the first battery chemistry. For example, the first and second traction battery packs 13 and 50 could include battery cells having a battery chemistry of NiMH, LFP (lithium iron phosphate), NCM (nickel, cobalt, manganese), Ni—Si (nickel silicon), or solid state.

FIG. 3 illustrates another example electrical system 12-1. The electrical system 12-1 is similar to the electrical system 12, except where described below or shown in the Figures. Similar components in the electrical system 12-1 will use the addition of a “-1” at the end of the reference number while other components will retain the same reference number from the electrical system 12 described above. The electrical system 12-1 provides power to the motor(s) 18 through a first traction battery 13-1 having a fixed traction battery segment 13-1A and a removable traction battery segment 13-1B. While the fixed traction battery segment 13-1A may be removed from the vehicle, it is intended to remain attached to the vehicle body 41 when the removable traction battery segment 13-1B is removed from the vehicle 40. For example, the removable traction battery segment can be removed when traveling short distances to reduce vehicle weight or to be swapped with another removable traction battery segment 13-1B that is already charged. This avoids waiting for the removeable traction battery segment 13-1B to charge in addition to the fixed traction battery segment 13-1A.

The fixed traction battery segment 13-1A includes a first plurality of battery modules each having plurality of battery cells and the removable traction battery segment 13-2 includes a second plurality of battery modules each having a plurality of battery cells. In one example, the fixed and removable traction battery segments 13-1A and 13-1B include a common battery chemistry.

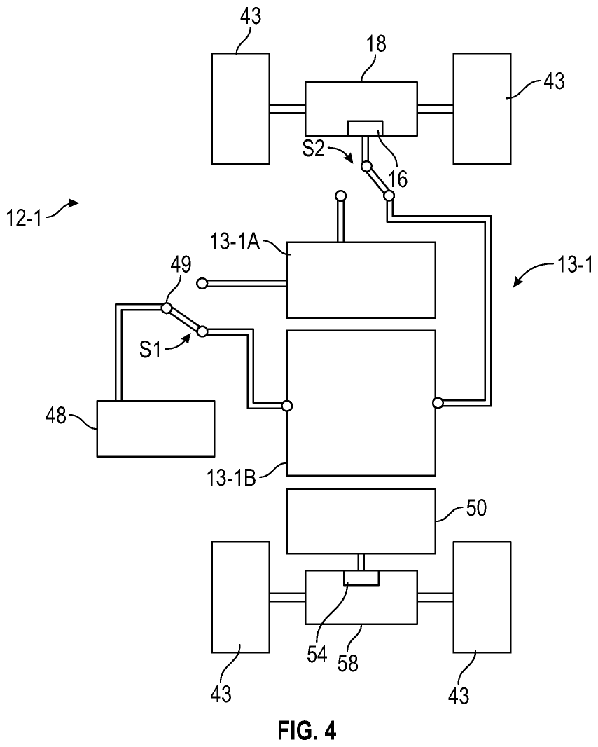

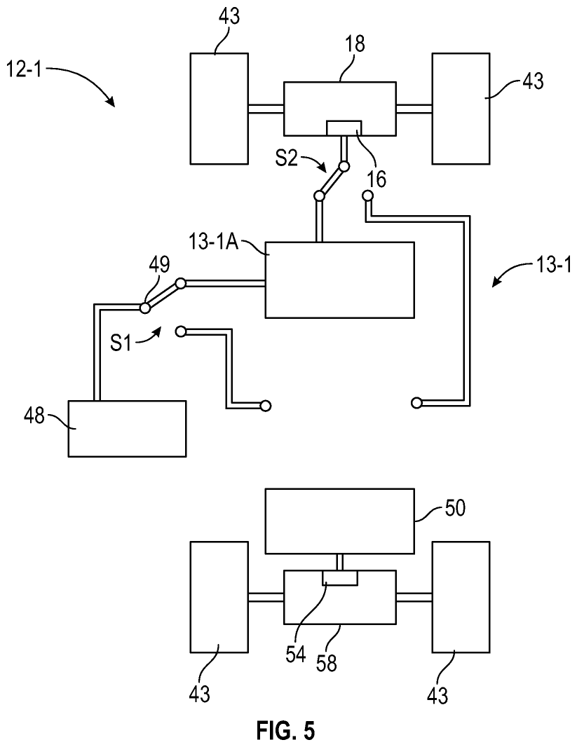

FIGS. 4 and 5 schematically illustrate various configurations of utilizing the electrical system 12-1 in the vehicle 40. In particular, when an external power source 48 is being used to charge one of the fixed traction battery segment 13-1A or the removable traction battery segment 13-1B, a first switch S1 or input switch is selectively movable between a first position to charge the fixed traction battery segment 13-1A (FIG. 5) and a second position to charge the removable battery segment 13-2 (FIG. 4). A second switch S2 or output switch is selectively movable between a first position with the fixed traction battery segment 13-1A in electrical communication with the motor(s) 18 and a second position with the removable traction battery segment 13-1B in electrical communication with the motor(s) 18.

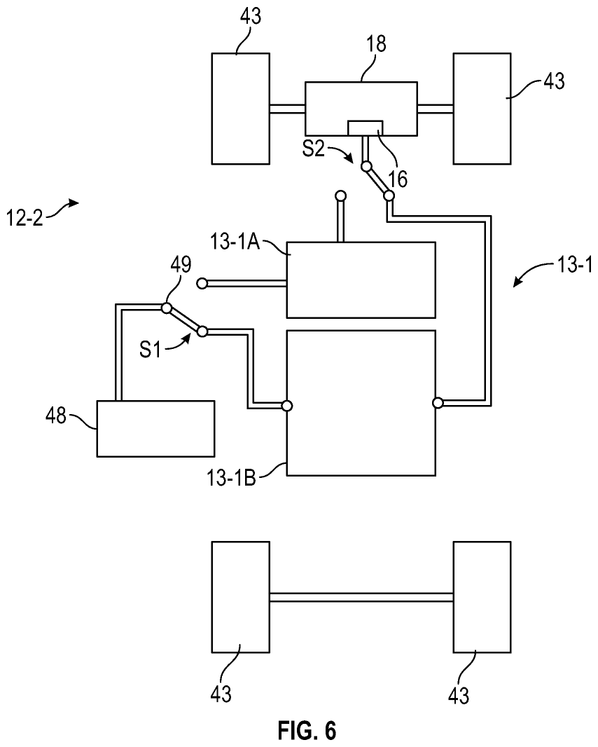

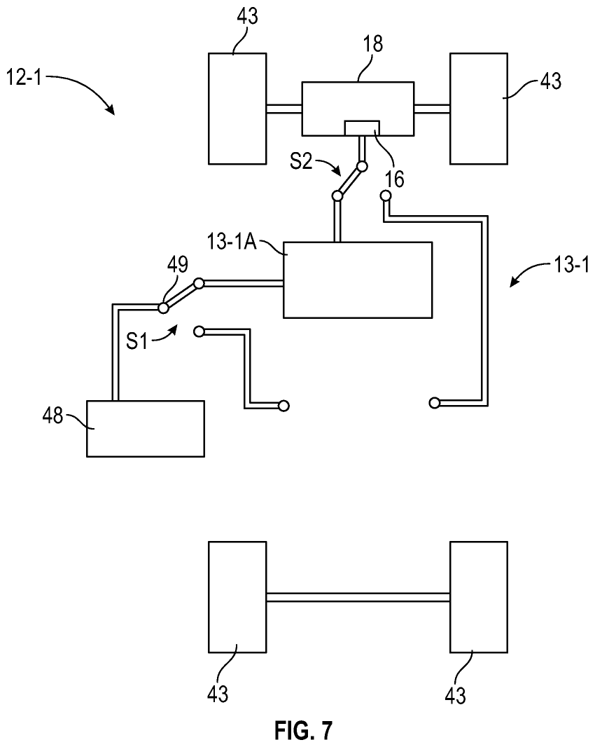

FIGS. 6 and 7 schematically illustrate another example electrical system 12-2. The electrical system 12-2 is similar to the electrical system 12-1 except where described below or shown in the figures. While the electrical system 12-1 is utilized with an all-wheel drive vehicle 40, the electrical system 12-2 is utilized with a two-wheel drive vehicle 40. The electrical system 12-2 only drives two of the wheels 43 on the vehicle 40 by eliminating the second traction battery pack 50 and the motor 58 along with their associated components, such as the second high-voltage bus 20-H2 with the second inverter 54. The driven wheels 43 with the electrical system 12-2 can be either a front pair of wheels 43 or a pair of rear wheels 43 depending on a desired vehicle dynamic. The remaining components in the electrical system 12-2 remain the same as the components in the electrical system 12-1.

FIG. 8 illustrates a method 100 of operating the vehicle 40 with either of the electrical systems 12 or 12-1. In particular, the method 100 begins by receiving a desired operating request from the vehicle 40 at Block 102. For example, the desired operating request for the vehicle 40 can include a change in speed of the vehicle 40, such as accelerating or decelerating the vehicle 40, or a desire to continue to maintain the same speed.

The method 100 then proceeds to Block 104 to analyze current operating conditions of the vehicle 40 in relation to the desired operating request. In one example, the current operating conditions can include at least one of ambient temperature surrounding the vehicle 40, a state of charge of the traction battery packs, or an operating temperature of the traction battery packs. The method 100 then proceeds to Block 106 to determine a mode of operation based on the analysis from Block 104.

At Block 106, the method 100 selects a mode of operation for the traction battery packs 13, 13-1, or 50 to use to meet the desired operating request. In one example, the desired operating request may include an acceleration of the vehicle 40 beyond a predetermined threshold level. In this case, the method 100 may utilize the first and second traction battery packs 13, 13-1, and 50 to provide maximum acceleration for the vehicle 40.

In another example, the method 100 may determine not to utilize the first traction battery pack 13 due to improved operating characteristics of the second traction battery pack 50 for the current operating conditions. In particular, the current operating conditions may include operating the vehicle 40 below a predetermined threshold temperature and the second traction battery pack 50 may exhibit better cold weather operating performance when compared to the first traction battery pack 13, 13-1. Therefore, the method 100 may select to operate to second traction battery pack 50 in connection with the motor 58 up to a predetermined point to optimize overall battery life of the vehicle 40.

In yet another example, the method 100 may determine that the desired operating request includes decelerating the vehicle 40 such that the motor 58 can operate as a generator to charge the second traction battery pack 50 to be within a predetermined charge range. Alternatively, if the second traction battery pack 50 is below the predetermined charge range, then the method 100 can utilize the motor 58 as a generator if the first traction battery pack 13 or 13-1 and the motor(s) 18 can satisfy the desired operating request.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. A powertrain system comprising:
a first traction battery pack;
a first drive unit in electrical communication with the first traction battery pack and configured to drive at least one first wheel;
a first charge receptacle in electrical communication with the first traction battery pack; and
a second traction battery pack configured to drive at least one wheel and electrically isolated from the first traction battery pack.

2. The powertrain system of claim 1, wherein the second traction battery pack is in electrical communication with a second drive unit that is configured to drive at least one second wheel and the second traction battery pack is electrically isolated from the first charge receptacle.

3. The powertrain system of claim 2, wherein the first traction battery pack includes a first battery chemistry and the second traction battery pack includes a second battery chemistry different from the first battery chemistry.

4. The powertrain system of claim 2, wherein the at least one first wheel includes a pair of first wheels and the first drive unit includes a hub motor associated with each of the pair of first wheels.

5. The powertrain system of claim 2, wherein the first traction battery pack includes a first plurality of battery modules located in a first battery housing and a second plurality of battery modules located in a second battery housing.

6. The powertrain system of claim 5, wherein the first traction battery pack includes a switch for selectively forming an electrical connection with the first plurality of battery modules or the second plurality of battery modules.

7. The powertrain system of claim 5, where in the first traction battery pack includes an output switch for selectively forming an electrical connection between the first drive unit and one of the first plurality of battery modules or the second plurality of battery modules.

8. The powertrain system of claim 2, wherein the first drive unit is in electrical communication with the first traction battery pack through a first inverter and the second drive unit is in electrical communication with the second traction battery pack through a second inverter.

9. A vehicle system comprising:
a vehicle body supported by a first pair of wheels and a second pair of wheels;
a first traction battery pack;
a first drive unit in electrical communication with the first traction battery pack and in driving engagement with at least one of the first pair of wheels;
a first charge receptacle in electrical communication with the first traction battery pack; and
a second traction battery pack electrically isolated from the first traction battery pack.

10. The vehicle system of claim 9, wherein the second traction battery pack is in electrical communication with a second drive unit that is configured to drive at least one second wheel and the second traction battery pack is electrically isolated from the first charge receptacle.

11. The vehicle system of claim 10, wherein the first traction battery pack includes a first battery chemistry and the second traction battery pack includes a second battery chemistry different from the first battery chemistry.

12. The vehicle system of claim 10, wherein the first traction battery pack includes a first plurality of battery modules and a second plurality of battery modules with one of the first plurality of battery modules or the second plurality of battery modules being fixedly attached to the vehicle body and the other of the first plurality of battery modules or the second plurality of battery modules being removably attached to the vehicle body.

13. The vehicle system of claim 12, wherein the first traction battery pack includes a switch for selectively forming an electrical connection with the first plurality of battery modules or the second plurality of battery modules.

14. The vehicle system of claim 12, where in the first traction battery pack includes an output switch for selectively forming an electrical connection between the first drive unit and one of the first plurality of battery modules or the second plurality of battery modules.

15. The vehicle system of claim 12, wherein the first plurality of battery modules are located in a first battery housing and the second plurality of battery modules are located in a second battery housing separate from the first battery housing.

16. A method of operating a vehicle, the method comprising:
receiving a desired operating request for the vehicle, wherein the desired operating request includes a requested velocity for the vehicle;
analyzing current operating conditions of the vehicle; and
selecting a mode of operation for the vehicle based on analyzing the current operating conditions and the desired operating request, wherein selecting the mode of operating includes operating a first drive unit in connection with a first traction battery pack to drive at least one first wheel on the vehicle, operating a second drive unit in connection with a second traction battery pack to drive at least one second wheel on the vehicle, and the second traction battery pack is electrically isolated from the first traction battery pack.

17. The method of claim 16, wherein operating the second drive unit includes operating the second drive unit as a motor to output a rotational force.

18. The method of claim 16, wherein operating the second drive unit includes operating the second drive unit as a generator to charge the second traction battery pack.

19. The method of claim 16, wherein the first drive unit is operated at a first voltage level, the second drive unit is operated at a second voltage level different from the first voltage level, and the current operating conditions of the vehicle include at least one of ambient temperature, a state of charge of the first traction battery pack or the second traction battery pack, or an operating temperature of the first traction battery pack or the second traction battery pack.

20. The method of claim 16, including charging the first traction battery pack through a first charge receptacle on the vehicle, wherein the first charge receptacle is isolated from the second traction battery pack.
